(19) United States
(12) Patent Application Publication
(10) Pub. No.: US 2009/0251771 A1
(43) Pub. Date: Oct. 8, 2009

(54) APPARATUS AND METHOD FOR ENHANCED OPTICAL TRANSMISSION THROUGH A SMALL APERTURE, USING RADIALLY POLARIZED RADIATION

(75) Inventors: Robert Frans Maria Hendriks, Eindhoven (NL); Marcello Leonardo Mario Balistreri, Rosmalen (NL); Gert W. 'T Hooft, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,562

(22) PCT Filed: Dec. 19, 2005
(86) PCT No.: PCT/IB05/54321

§ 371 Date: Jun. 13, 2007

(30) Foreign Application Priority Data
Dec. 22, 2004 (EP) 04106864.4

(51) Int. Cl. H01S 3/16; G02B 5/30

(52) U.S. Cl. 359/342; 359/485

(57) ABSTRACT

An apparatus for enhanced transmission of radiation, comprising at least one radiation source (12), a metal plate (18) with a first (20) and a second (22) surface and at least one aperture (24) provided in the metal plate (18) and extending from the first (20) to the second (22) surface, the metal plate (18) having a periodic surface topography (26) provided on at least one of the first (20) and the second (22) surfaces, and radiation (13) coming from the radiation source (12) and being incident on one of the surfaces (20,22) of the metal plate (18) interacts with a surface plasmon mode on at least one of the surfaces of the metal plate (18), thereby enhancing transmission of radiation through the at least one aperture (24) of the metal plate (18). The apparatus for enhanced optical transmission comprises means (15) for generating radially polarized radiation (16), which is incident on one of the surfaces (20,22) of the metal plate (18) with a surface topography (26), resulting in a more efficient coupling of the radiation to the plasmons and thereby in a further enhancement of the optical transmission.

The present invention relates to an apparatus for enhanced optical transmission as defined in the pre-characterizing part of claim 1.

The invention also relates to a read/write head for an optical storage medium as defined in claim 19, a near field optical scanning microscope as defined in claim 20, and a bright radiation source as defined in claim 21.

The invention further relates to a method for enhanced optical transmission as defined in claim 22.

In the field of near field optical devices, such as near field-scanning microscopes and optical data storage devices, the use of sub-wavelength apertures to improve the resolution of the device is generally known.

The transported radiation through a sub-wavelength aperture—the throughput—in even a flat metal plate is extremely low. The efficiency of the transmitted optical power through the aperture is limited by Bethe's formula, being (λ/d)⁴ when the radius is smaller than the wavelength of the used radiation: d<<λ. In this formula, λ is the wavelength of the radiation and d is the diameter of the hole in the aperture.

Consequently, it is obvious that the optical transmission through sub-wavelength apertures is strongly limited by the diameter of the aperture.

For applications in the near field, such as near field optical microscopes or read/write heads for optical data storage devices, the achieved intensity of the radiation is not sufficient for many applications and results in very long scanning times (read and/or write) of a record carrier or observation times in near field optical microscopes.

It is generally known to enhance the throughput through small holes, such as apertures in these devices, by coupling the incident radiation to surface plasmons—the creation of surface-plasmon-polaritons. If the coupling is resonant, which means that the wavelength of the radiation matches the wavelength of the surface plasmons, the electric field is enhanced, resulting in an enhanced transmission.

It is known from several patent applications and patents, for instance, US 2003/0173501 A1, EP 1008 870A1, US EP 1 128 372 A2 and U.S. Pat. No. 6,236,033, to enhance the transmission through such sub-wavelength apertures, using a plate with the aperture built in, with regularly structured surfaces facing a radiation source.

US 2003/01 73501 A1 discloses an apparatus for enhanced radiation transmission. The apparatus comprises a metal plate having a first surface and a second surface, while at least one aperture is provided in the metal film and extends from the first surface to the second surface.

The at least one aperture comprises an entrance portion disposed on the first surface of the metal film and an exit portion disposed in the second surface of the metal film, each portion having a cross-sectional area in the plane of the corresponding metal film surface, wherein the cross-sectional area of the entrance portion is not equal to the cross-sectional area of the exit portion. A periodic surface topography is provided on at least one of the first and the second surface of the metal film, the periodic surface topography comprising a plurality of surface features.

One of the surface structures, called the “bull's eye pattern”, comprises depressed concentric rings which are arranged concentrically around a single aperture. The surface feature consisting of concentric circular rings is arranged on the surface facing the radiation source, wherein the second surface is provided only with the single aperture. When radiation is incident on the surface with the concentric circular rings, output radiation having an enhanced intensity is transmitted from the aperture at the second surface.

The explanation of the enhanced transmission is based on the fact that surface plasmons are excited at the corrugation of the bull's eyes and that these surface plasmons transport the energy through the aperture.

An apparatus for further enhanced optical transmission is reported in WO 03/019249 A2. In this apparatus, a directionality and divergence control is provided by arranging a surface topography on the surface of a metal plate from which the output radiation is directed. Whereas the angular distribution of the transmitted radiation is isotropic in the case of the apparatus disclosed in US 2003/0173501 A1, the angular distribution of the transmitted radiation is non-isotropic in the embodiments disclosed in WO 03/019245 A2.

This non-isotropic angular distribution of the transmitted radiation leads to a further improvement of the optical transmission. The improvements of the optical transmission have been achieved by adapting the geometry of the surface feature and the geometry of the aperture. The disadvantage resides in the rather complicated structure of the surface feature and the fact that both surfaces of the metal plate have to be structured.

Moreover, the achieved intensity is still not sufficient for many applications of sub-wavelength apertures.

It is therefore an object of the present invention to provide an apparatus of the type mentioned in the opening paragraph, which obviates the above drawback. In particular, it is the object of the present invention to provide an apparatus for further enhancement of the optical transmission for applications using sub-wavelength apertures in general.

According to the invention, a further enhancement of the optical transmission can be achieved by an apparatus of the type mentioned in the opening paragraph, which apparatus comprises means for generating radially polarized radiation, which is incident on one of the surfaces of the metal plate with a surface topography, resulting in a more efficient coupling of the radiation to the plasmons and thereby in a further enhancement of the optical transmission.

The apparatus of the present invention takes the nature of the surface plasmons into account.

Surface plasmons in a metal are vibrational modes of the electron gas density oscillating about a core of the metal ion. Surface plasmons describe the special case in which the charges are confined to the surface of the metal. In this case, the electric field is strongest in the plane of the metallic surface. Plasmons confined to a plane do not radiate light. However, when the local symmetry is disturbed, plasmons can radiate. Surface plasmon emission from defects in metal surfaces is known and described in several publications and will not be described here in more detail. A periodic pattern of surface topography, called surface features, provides the coupling of the incident radiation to the surface plasmons modes, when the energy and the momentum conservation are kept. Then a resonant enhancement of the electric fields around the hole, the aperture, leads to enhanced transmitted intensity of the radiation far from what would have been expected from Bethe's formula. Surface plasmons have a component of the wave vector kₛₚ parallel to the surface. Consequently, only radiation that is perpendicularly incident on the surface can couple more efficiently to the surface plasmons.

In radially polarized radiation, the electric field is oriented along a line extending through a symmetry axis of the center of a radiation beam. Using radially polarized radiation, the electric field vector is thus always perpendicular to the surface features, in particular grooves of the metal plate.

Radially polarized radiation that has a direction of polarization perpendicular to the surface feature of a metal plate comprising the aperture will couple most efficiently to the plasmons and excite them. In contrast to uniformly polarized radiation, radially polarized radiation has the advantage that one hundred percent of the radiation has the proper electric field to excite the surface plasmon.

Due to the fact that all of the radiation has a proper polarization, the efficiency of the optical transmission can be increased by a factor of two as compared to linearly polarized radiation used in the prior art.

An application of a sub-wavelength aperture will be explained hereinafter to demonstrate the working principle of the apparatus for enhanced optical transmission.

The set-up of an apparatus for enhanced optical transmission will be explained by way of example for a near field-scanning microscope. A near field-scanning microscope comprises a radiation source, a device for generating radially polarized radiation and a metal plate with a first surface and a second surface, wherein an aperture, which has sub-wavelength dimensions, extends from the first surface to the second surface.

At least one of the surfaces is equipped with a periodical surface topography. These are the key components of the apparatus for enhanced optical transmission of the present invention. This apparatus can generally be built in every device in which a high optical transmission with a high resolution is required, for example, in near field microscopy or high-density optical data storage devices, or in other devices in which such an apparatus is useful.

The metal plate may be made of pure solid metal or may comprise a metal film. The material comprising the metal film may be any conductive material, such as any metal, but it need not be a metal. For example, a metal plate may comprise a doped semiconductor, and preferably aluminum, silver or gold. A special embodiment is a free-standing Ni-film having a thickness of 300 nm and coated on one side with a 100 nm Ag layer. All of these embodiments are included in the following description when a metal plate is concerned. The metal plate has at least one aperture or hole. The at least one aperture comprises an entrance portion and an exit portion. The aperture entrance portion is disposed on the surface of the metal plate upon which radiation will be incident, such that radiation enters the aperture through the entrance portion and exits the aperture through the exit portion. At least one of the surfaces of the metal plate includes a periodic surface topography as will be described below.

The aperture has sub-wavelength dimensions of several tenth to several hundred nm. For instance, when a neon laser is used as a radiation source, which has a wavelength of 633 nm, a preferred aperture diameter will be 215 nm. The metal plate can also be provided with a surface topography structure on both surfaces, the first surface and the second surface.

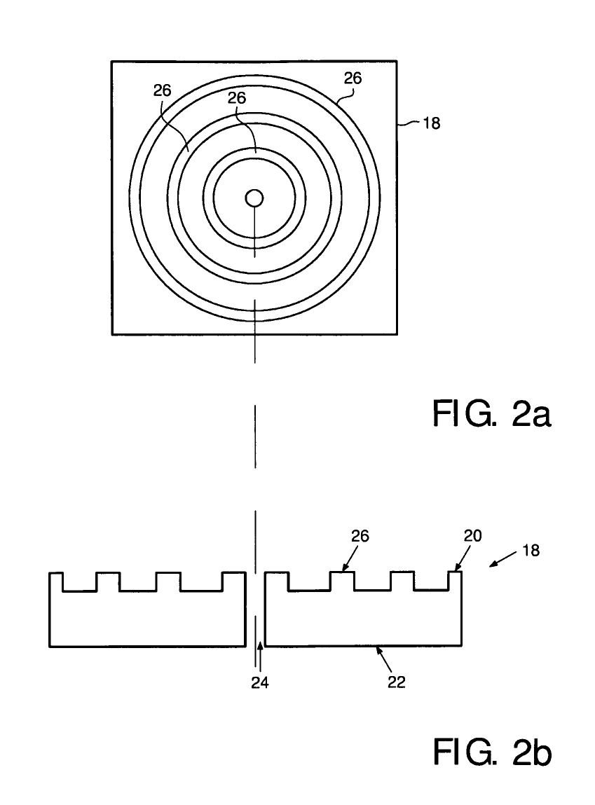

A surface which includes a periodic surface topography is any surface having raised and/or depressed regions—as opposed to a substantially smooth surface—wherein such regions are arranged with a periodicity or in a regularly repeated pattern. One embodiment of a surface topography structure is shown in FIG. 2 and will be discussed hereinafter. A plurality of surface structures will be understood as topography, in particular a surface in which a plurality of cylindrical or semi-spherical concave depressions (dimples) is provided, the dimples being arranged in a periodic pattern on the surface; a surface in which a plurality of cylindrical or semi-spherical protrusions is provided, the semi-spherical protrusions being arranged in a periodic pattern on the surface; a surface in which a plurality of curved or linear depressed grooves is provided, the grooves being arranged in a periodic pattern on the surface; a surface in which a plurality of curved or linear raised ribs is provided, the ribs being arranged in a periodic pattern on the surface; a surface in which a plurality of depressed or raised rings is provided, the rings being arranged in a periodic pattern (in general, concentrically) on the surface, and any combination of the above.

In general, the periodic surface topography does not include the apertures provided in the metal plate. If desired, also the plurality of such apertures could be provided

The term “surface feature” will be used hereinafter for these described surface topographies so as to distinguish between the apertures which extend throughout the thickness of the metal plate. These surface features will be used to refer to protrusions on and depressions in the surface which do not extend throughout the thickness of the metal plate and are therefore not apertures. For example, dimples, semi-spherical protrusions, grooves, rings and splines are surface features. Also included will be metal plates, which have different surface features than those mentioned above, either on one or on both surfaces.

The geometry of the aperture may also include apertures which have the same diameter at the entrance and exit portions or apertures which have different diameters at the entrance and exit portions. This means that the entrance portion may have a larger diameter than the exit portion, or vice versa.

In conformity with the surface structure of the at least one surface of the metal plate, radiation incident on the surface will excite surface plasmons, which transport the energy of the radiation through the aperture. Using radially polarized radiation, the electric field vector of the radiation is always perpendicular to the surface.

The surface plasmons have a wave vector parallel to the surface, which is larger than the wave vector of the radiation in the material surrounding the metal plate. Consequently, radiation which is perpendicularly incident on the surface can pick up the large component of the wave vector parallel to the surface. A hundred percent of the radiation thus has the same direction relative to the surface of the metal plate or, in other words, to the wave vector of the excited surface plasmons.

The use of radiation having the direction of the electric field vector perpendicular to the surface results in a doubling of the transmission through the aperture, as compared to randomly polarized radiation, in which only half the radiation is perpendicularly incident on the surface.

According to a preferred embodiment of the present invention, the means for generating radially polarized radiation comprises a radiation source for emitting a radiation beam, which is preferably linearly polarized, and the device for changing the linearly polarized radiation into radially polarized radiation.

The radiation source is preferably a semiconductor laser, emitting radiation having a wavelength in accordance with the requirements of the device, while the apparatus is built in. The wavelengths are typically between 480 nm and 780 nm. The device for generating polarized radiation is arranged behind the radiation source in an optical path of the apparatus.

The radially polarized radiation has an electric field vector oriented along a line extending through the symmetry center of the radiation beam. Advantageously, the device uses several possible ways of generating the polarized radiation beam.

According to a further embodiment, the apparatus comprises a Lee-type binary grating to form the radially polarized radiation.

In this case, the radiation coming from the radiation source passes a sub-wavelength grating, called the Lee-type binary grating, before entering the aperture. Typically, the Lee-type binary grating comprises metal strips of 10 nm Ti and 60 nm Au, which were deposited onto a 500 μm thick GaAs wafer by means of photolithography and a lift-off technique. Both techniques of producing such a device have the advantage that they are well known.

According to a further embodiment of the invention, the radiation coming from the radiation source passes a quarter-wave plate to form radially polarized radiation.

When linearly polarized radiation is incident on such a quarter-wave plate, a radially polarized radiation beam is generated. It should be noted that the polarization of linearly polarized radiation is rotated 2θ, using an angle of θ between the optical axis of the quarter-wave plate and the direction of the electric field. The use of four quarter-wave plates results in an approximated radial polarization distribution, e.g. a combination of two orthogonal linearly polarized beams.

According to a further embodiment of the invention, the radiation passes a quarter-wave plate and a phase plate to form the radially polarized radiation.

It is advantageous to use a phase plate because radially polarized beams often have a phase singularity which can be removed by a phase plate.

According to a further embodiment of the invention, the radiation passes through a liquid crystal device before it is incident on the surface of the aperture.

Liquid crystal devices can be used to generate radially and azimuth-polarized radiation. Liquid crystal devices are flexible in the design of new optical components. Depending on the orientation of the linearly polarized radiation incident on the liquid crystal device, either radially or azimuth-polarized radiation will be generated.

A liquid crystal device generally comprises two plates having electrodes to generate an electric field in between the plates and a layer of liquid crystal molecules acting as birefringence material. By applying the electric field, the liquid crystal molecules will be aligned. The liquid crystal device has thus become a polarizer, acting as a radial analyzer.

Liquid crystal devices are used for several optical devices and can be manufactured easily and at low cost.

The object of the invention is further solved by a read/write head for an optical data storage media comprising an apparatus as defined in the opening paragraph, the apparatus comprising a radiation source, a metal film with a first and a second surface, at least one aperture provided in the metal film and extending from the first to the second surface, a periodic surface topography provided on at least one of the first and the second surfaces of the metal film, wherein radiation coming from the radiation source incident on one of the surfaces of the metal film interacts with the surface plasmon mode on at least one of the surfaces of the metal film, thereby enhancing transmission of radiation through the at least one aperture of the metal film, and wherein the read/write head comprises an apparatus with means for generating radially polarized radiation.

A read/write head requires a good resolution, which is achieved by using an aperture with sub-wavelength dimensions and at the same time a radiation beam with a slightly high intensity for scanning an optical record carrier. Consequently, the further enhancement of the transmission of the radiation beam by using an apparatus, which comprises means for generating radially polarized radiation, is advantageous.

The object of the present invention is further solved by a near field optical scanning microscope comprising a radiation source, a metal film with a first and a second surface, at least one aperture provided in the metal film and extending from the first to the second surface, a periodic surface topography provided on at least one of the first and the second surf-ace of the metal film, wherein radiation coming from the radiation source incident on one of the surfaces of the metal film interacts with the surface plasma mode on at least one of the surfaces of the metal film, thereby enhancing transmission of radiation through the at least one aperture of the metal film, and wherein the near field optical scanning microscope comprises means for generating radially polarized radiation incident on one of the surfaces of the metal film, resulting in a further enhancement of the radiation transmission.

In near field optical microscopy, the radiation beam must have a certain intensity and a good resolution. It is therefore advantageous to use a means for enhancing the transmission through a sub-wavelength aperture by using radially polarized radiation in combination with an aperture having a surface feature. Up to a factor of two or more of the radiation incident on the aperture can thus be transmitted by increasing the number of excited surface plasmons.

This is an advantage, because the key problem of a near field optical microscope is to achieve transmission at a simultaneously small resolution in a very simple way. This problem is solved by adding means for transforming the radiation into radially polarized radiation.

The object of the invention is also solved by a method, wherein radially polarized radiation is used to irradiate a sub-wavelength aperture having surface features in order to increase the number of excited surface plasmons.

The method of enhancing optical transmission in a device using radiation in the nanometer range and comprising a sub-wavelength aperture advantageously uses radially polarized radiation incident on the metal plate having surface features so as to achieve the excitation of plasmons by every photon from the radiation beam incident on the metal plate.

It is to be understood that the afore-mentioned features and those still to be explained below are not only applicable in the combinations given, but also in other combinations or in isolation without departing from the scope of the invention.

These and other objects and advantages of the present invention are more apparent from the following description with reference to the accompanying drawings, in which:

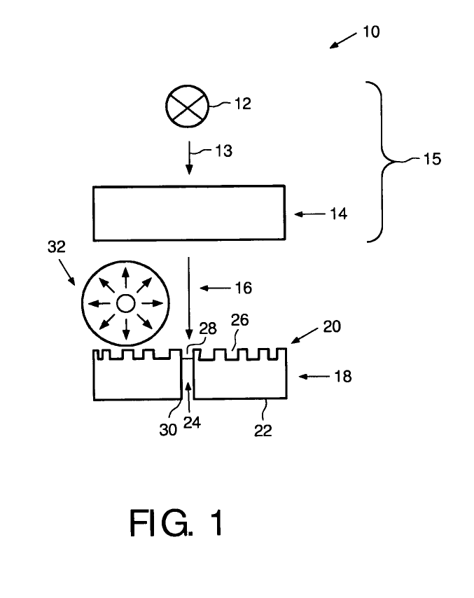

FIG. 1 is a schematic diagram of an example of an optical path of the present invention;

FIG. 2 shows a bull's-eye structure. FIG. 2a is a plan view image and FIG. 2b is a diagrammatic cross-section of the structure;

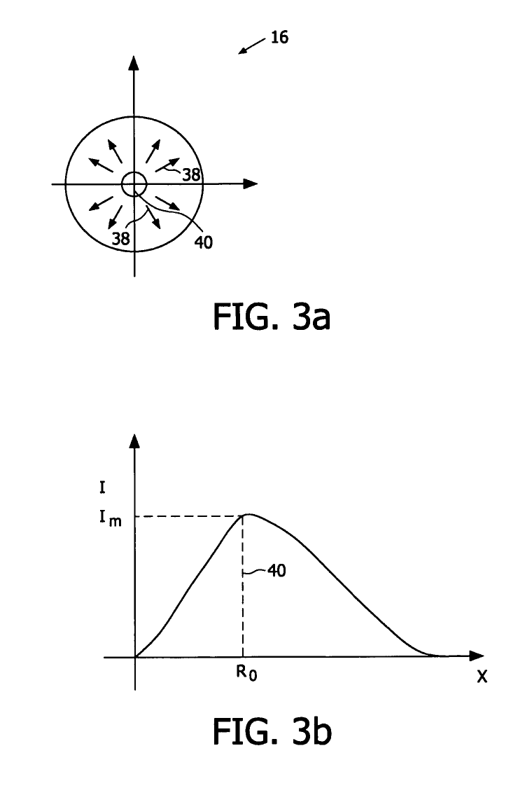

FIG. 3 shows schematic features of a radially polarized beam;

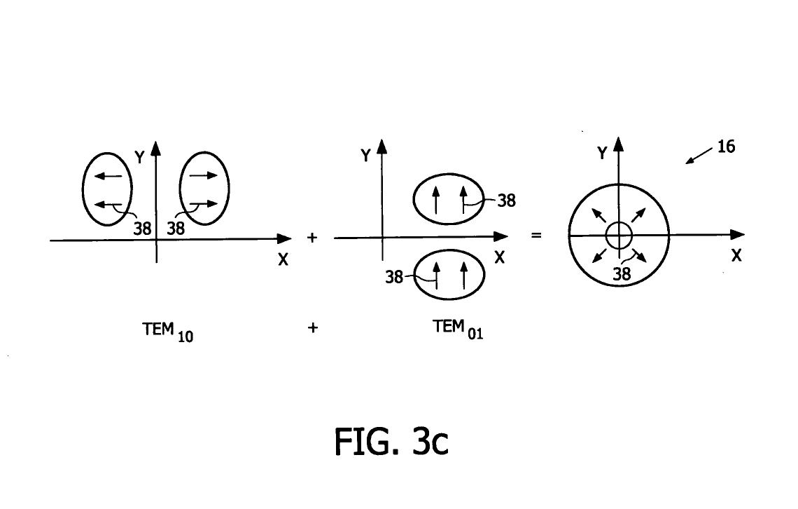

FIG. 4 shows an alignment of a quarter-wave plate (a) and a phase plate (b);

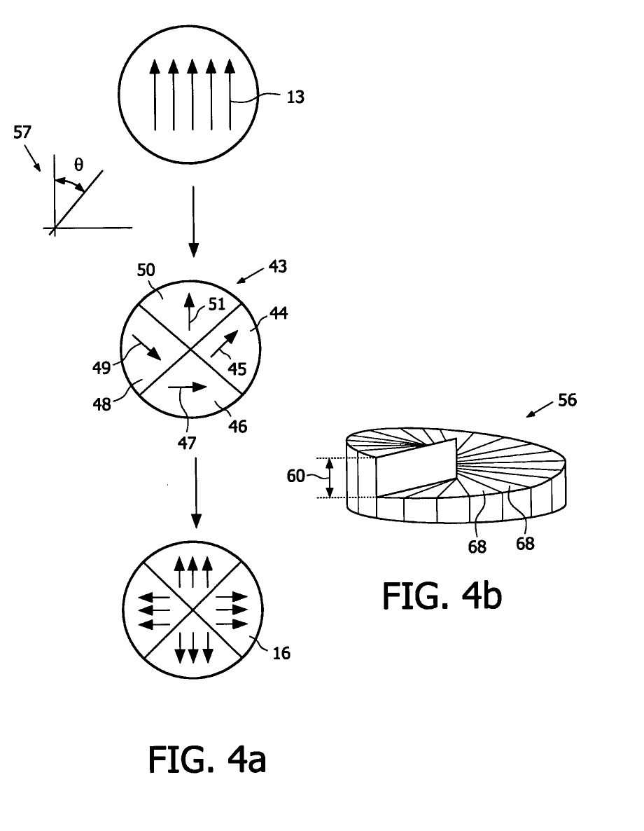

FIG. 5 is a schematic diagram of a liquid crystal (LC) cell for generating radially polarized radiation;

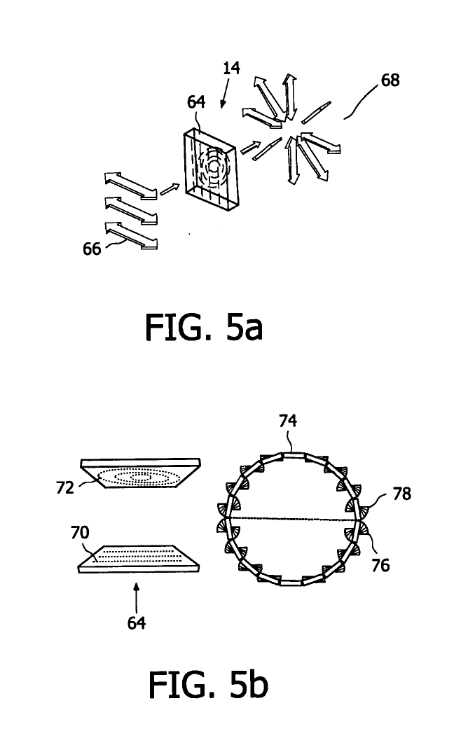

FIG. 6 is a schematic view of a laser emitting radially polarized light;

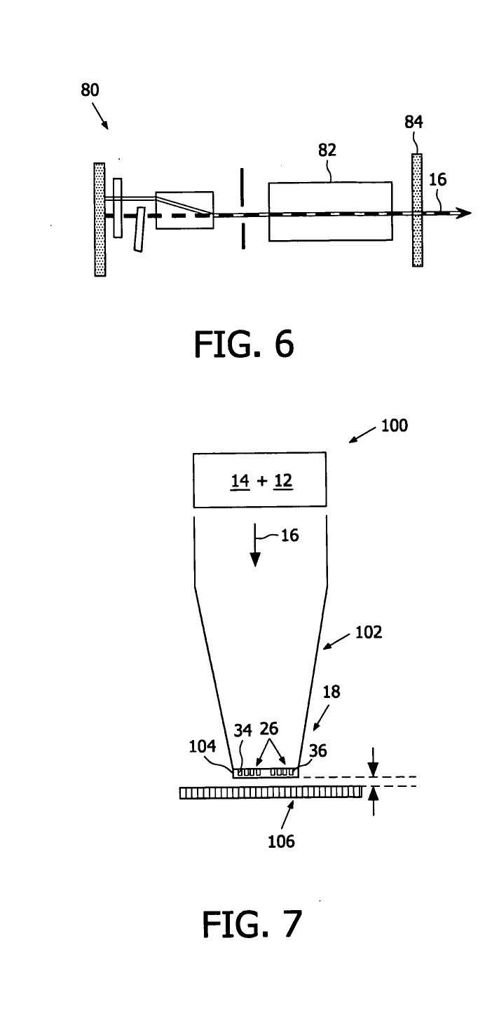

FIG. 7 is a cross-sectional view of a read/write head based on a tapered optical fiber with a bull's eye structure (a), and a plan view of a bull's eye structure (b);

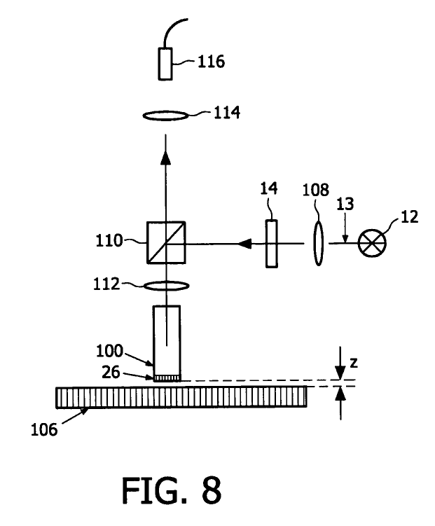

FIG. 8 shows an optical path of an optical pick-up unit with a read/write head according to the embodiment shown in FIG. 7.

FIG. 1 is a schematic diagram of an apparatus 10 for enhanced optical transmission comprising means for generating a radially polarized radiation beam, in particular a radiation source 12, emitting a radiation beam 13, a device 14 for generating radially polarized radiation 16, and a metal plate 18 with a first surface 20 and a second surface 22, wherein an aperture 24 extends from the first surface 20 to the second surface 22. At least one of the surfaces 20 or 22 is equipped with a periodical surface topography 26. These are the key components of the apparatus 10 for enhanced optical transmission of the present invention. This apparatus 10 can generally be built in every device in which a high optical transmission with a high resolution is required, for example, in near field microscopy or high-density optical data storage devices, or in other devices in which such an apparatus 10 is useful.

Prior to describing particular embodiments of the invention, it will be useful to elucidate several terms which are important for understanding the invention, in particular the metal plate 18 with the aperture 24 and the device 14 for generating the radially polarized radiation 16. The metal plate 18 may be made of pure solid metal or may comprise a metal film. The material comprising the metal film may be any conductive material, such as any metal, but it need not be a metal. For example, the metal plate 18 may comprise a doped semiconductor. The metal plate 18 preferably comprises aluminum, silver or gold. A special embodiment is a free-standing Ni-film having a thickness of 300 nm and coated on one side with a 100 nm Ag layer. All of these embodiments are included when a metal plate 18 is concerned. The metal plate 18 has at least one aperture or hole 24. The at least one aperture 24 comprises an entrance portion 28 and an exit portion 30. The aperture entrance portion 28 is disposed on the surface of the metal plate 18 upon which radiation will be incident, such that radiation enters aperture 24 through entrance portion 28 and exits aperture 24 through exit portion 30. At least one of the surfaces of the metal plate 18 includes a periodic surface topography 26 as will be described below.

The aperture 24 has sub-wavelengths dimensions of several tens to several hundred nm. For instance, when a neon laser is used as a radiation source 12, which has a wavelength of 633 nm, a preferred aperture diameter will be 215 nm. The metal plate 18 can also be provided with a surface topography structure on both surfaces, the first surface 20 and the second surface 22.

A surface which includes a periodic surface topography is any surface having raised and/or depressed regions—as opposed to a substantially smooth surface—wherein such regions are arranged with a periodicity or in a regularly repeated pattern. One embodiment of a surface topography structure is shown in FIG. 2 and will be discussed hereinafter. All generally possible surface topography structure will be discussed. The wording “surface topography” may include:
1. A surface in which a plurality of cylindrical or semi-spherical concave depressions (dimples) is provided, the dimples being arranged in a periodic pattern on the surface;
2. a surface in which a plurality of cylindrical or semi-spherical protrusions is provided, the semi-spherical protrusions being arranged in a periodic pattern on the surface;
3. a surface in which a plurality of curved or linear depressed grooves is provided, the grooves being arranged in a periodic pattern on the surface;
4. a surface in which a plurality of curved or linear raised ribs is provided, the ribs being arranged in a periodic pattern on the surface;
5. a surface in which a plurality of depressed or raised rings is provided, the rings being arranged in a periodic pattern (e.g. concentrically) on the surface; and
6. any combination of the above.

In general, the periodic surface topography does not include the apertures 24 provided in the metal plate 18. If desired, also the plurality of such apertures could be provided.

The term “surface feature” 27 will be used hereinafter for these described surface topographies so as to distinguish it from the aperture 24 which extends throughout the thickness of the metal plate 18. These surface features 27 will be used to refer to protrusions on and depressions in the surface which do not extend throughout the thickness of the metal plate and are therefore not apertures. For example, dimples, semi-spherical protrusions, grooves, rings and splines are surface features. Also included will be metal plates 18, which have different surface features than those mentioned above, either on one surface or on both surfaces.

The geometry of the aperture 24 may also include apertures which have the same diameter at the entrance and exit portions or apertures 24, which have different diameters at the entrance and exit portions. This means that the entrance portion may have a larger diameter than the exit portion, or vice versa.

Reference will now be made to the device 14 for generating radially polarized radiation as shown in the insert 32. The device 14 may include several embodiments as indicated in FIGS. 3, 4 and 5. Regarding the invention, it is only important that, after having passed the device 14, the radiation has all the features of radially polarized radiation, which will be described hereinafter. Radially polarized radiation 16 has the following features:
the electric and magnetic fields have a defined axis of radial symmetry concerning the direction of propagation;
on the axis of symmetry, the intensity has a value which is not different from zero and a maximum intensity in distinct distances R₀, R₁, . . . from the axis of symmetry, as shown in FIG. 3, with x being the distance from the axis of symmetry.

In a plane perpendicular to the axis of symmetry, the phase of the radiation has the same value for all points, which have the same distance to the axis of symmetry. Such a field distribution can be generated, for instance, by superposition of two orthogonally polarized TEM₀ₘ-TEMₘ₀-modes (m=1). FIG. 3 shows a superposition of two polarized TEM₁₀- and TEM₀₁-modes, with TEM₁₀ being one in the x-polarized mode and TEM₀₁ being one in the y-polarized mode. Special embodiments of the device 5 for generating radially polarized radiation are shown in FIGS. 4 and 5 and will be explained hereinafter.

The enhanced optical radiation transmission of the present invention operates as follows (FIG. 1). A radiation beam 13 emitted from the radiation source A, which is preferably a laser, in particular a HeNe laser with a wavelength of λ=633 nm, will be modified by the device 14 to a radially polarized radiation beam 18. This radiation beam 18 will be incident on the surface 20 of the metal plate 18.

The radiation is then directed to the entrance portion 28 of the aperture 24 and transmitted from the exit portion 30 of the aperture 24 at the second surface 22 of the metal plate 18 as output radiation having an enhanced intensity Iₒᵤₜₚᵤₜ. It should be noted that it is not important for the enhancement of the optical transmission through metal plate 18 on which surface 20 or 22 the surface feature 26 is arranged. It is also possible that a surface feature 26 is arranged on both sides of metal plate 18, i.e. on side 20 and on side 22. The enhancement of the transmission is due to resonant excitation of surface plasmons on the surface 20 on which the radiation is incident. The interaction is made by coupling through the grating moment and the obeyed conservation of momentum:

kₛₚ=kₓ±i·Gₓ±j·G_{y},

wherein kₛₚ is the surface plasmon wave vector, kₓ is a component of the incident wave vector that lies in the plane of the metal plate 18, Gₓ and G_{y} are the reciprocal lattice vectors for a square lattice with |±Gₓ|=|±G_{y}|=2π/a₀, and i, j are integers. The wave vector kₛₚ can also be expressed as:

$${K}_{sp} = \frac{2 Π}{λ \sqrt{\frac{{ɛ}_{1} {ɛ}_{m}}{{ɛ}_{1} + {ɛ}_{m}} ,}}$$

wherein ε₁ and εₘ are the dielectric constants of the surrounding dielectric and metal, respectively, wherein the dielectric constant εₘ of the metal is negative and has a much larger absolute value than most dielectrics. Surface plasmons have a component of the wave vector kₛₚ parallel to the surface, which is larger than the wave vector of the radiation in the dielectric material surrounding the metal plate 18.

If the radially polarized radiation which is incident on the surface 20 of the metal plate 18 is perpendicular to the surface, this radiation can pick up the large moment kₛₚ and excite the plasmons. This means that only the radiation that is perpendicular to the groove of the surface feature can excite plasmons. The more radiation is perpendicular to the groove and is incident on the surface feature, the more plasmons are excited and the higher the transmission is through the metal plate. Using randomly polarized radiation, only half the radiation has the proper polarization to only excite the plasmons. Using randomly polarized radiation, all of the radiation has a proper polarization to excite the plasmons. This leads to an expected optical transmission enhanced by a factor of 2.

Several devices 14 for converting the radiation beam emitted from the radiation source 12 into a radially polarized beam 16, in particular a Lee-type binary grating, are not shown in the Figures. Details can be read from the publication: Ze'ev Bomzon et al. in Optics Letters, Vol. 26, No. 18 (2001) p. 1424. Also a quarter-wave plate, shown in FIG. 4 can be taken for the device 14. Moreover, devices 14 that have not been mentioned are feasible, as long as they convert linearly polarized radiation into radially polarized radiation.

In FIG. 2, reference numerals are identical to those in FIG. I and identical parts are denoted by the same reference numerals.

FIG. 2a is a cross-sectional view of a surface feature 26 as disclosed in US 2003/0173501 A. The surface structure is called a bull's-eye structure. The structure is normally manufactured by means of a focused 1-beam method (SIB). The surface feature is realized on a silver (Ag)-film wherein the groove periodicity is 500 nm and the groove depth is 60 nm. The aperture 13 can be seen in the middle of the structure and has a diameter of 250 nm. The overall thickness is 300 nm. The picture was taken from a publication of Tineke, Thio in Optics Letters, Volume 26, No. 24, page 1972, Dec. 15, 2001.

The periodic surface topography consists of a set of depressed concentric rings with a mean radius given by Kₖ=kP (P=750 nm, k=1,2 . . . ). P is the periodicity of the periodic surface topography and denotes the number of rings. This surface feature structure is known as bull's eye pattern and has been investigated by several authors. The bull's eye structure is only an example of a surface feature 26 of the metal plate 18. Other surface features can be used to achieve the same effect of enhanced transmission through the metal plate 18 by plasmon excitation.

The invention also includes other surface features 26 disclosed, for instance, in US 2003/0173501, Tineke, Thio, Optics Letters, Volume 26, No. 24, page 1972, Dec. 15, 2001. It should be noted that the surface features can be arranged on both sides of the metal plate 18. In the cross-section of the bull's eye structure, the hills 34 and the valleys 36 do not have to be rectangular but may also be triangular, or the transition between a valley 36 and a hill 34 can be smoothed out.

FIG. 3 shows a radially polarized beam 16 in the x-y plane. The electric field vector is denoted by arrows 38 in FIG. 3a. FIG. 3b shows the intensity distribution as a function of the x-direction in FIG. 3a. It can be seen that a radially polarized beam typically has a maximum intensity distribution at a distance from the symmetry axis 40, which distance is denoted as R₀ in FIG. 3b.

FIG. 3c show the superposition of one TEM₁₀-mode polarized in the x-direction and one TEM₁₀-mode polarized in the y-direction, resulting in the radial beam 21 with the distribution of the electric field vector 38 and the symmetry axis 40.

FIG. 4 illustrates a linearly polarized radiation beam 13 through a quarter-wave plate 42 which is part of the device 14 for generating a radially polarized beam 16. This quarter-wave plate 42, which is also called polarization converter, comprises four quarter-wave plates 44, 46, 48 and 50. Reference numeral 13 denotes a radiation beam with a y-direction of polarization before passing the quarter-wave plate 42, and 16 denotes the radially polarized beam at the exit of the quarter-wave plate 42. The arrows 44, 46, 48 and 50 denote different orientations, at an angle θ=0° for the arrow 51, θ=45° for the arrow 45, θ=90° for the arrow 47 and θ=135° for the arrow 49. The angle θ is indicated at the insert 57 of the optical axis. This means that the optical axis varies across the quarter-wave plate 42. It should be noted that the polarization of linearly polarized radiation is rotated 2θ, using an angle of θ between the optical axis of the quarter-wave plate and the direction of the electric field. The use of four quarter-wave plates results in an approximated radial polarization distribution, e.g. a combination of two orthogonal linearly polarized beams. In this embodiment, the device 14 also includes a phase plate 56 which removes a phase singularity which is often carried by a radially polarized beam. In this context, phase singularity is understood to mean that the phase of the radiation increases or decreases by a multiple of 2π during rotation around the symmetry center, i.e. the axis. Phase plate 56 comprises sectors 58 which have different heights 60. The heights 60 should be adjusted to the wavelength of the incident radiation. In order to remove a singularity, the phase difference across the steps, the heights 60, should be 2π.

FIG. 5 shows another embodiment of the device 14 for generating radially polarized radiation. FIG. 5a shows the embodiment consisting of a φ cell 64 which changes linearly polarized radiation denoted by reference numeral 66 into radially polarized radiation indicated by arrows 68. In the embodiment of the φ cell, linearly polarized radiation 64 changes into radially polarized radiation indicated by arrows 68.

The φ cell 64 is shown in detail in FIG. 5b. The two layers 70 and 72 are aligned as indicated in FIG. 5b. Layers 70 and 72 consist of one unidirectionally and one circularly rubbed alignment layer filled with a nematic LC. The unidirectional alignment layer defines an axis referred to as cell axis. Because of its combination of linear and circular symmetry, the LC-cell is called the φ cell. The local LC orientation in this φ cell is that of a twisted cell with a variable twist angle defined by the local alignment layer.

The second part of FIG. 5, FIG. 5c, shows the orientation of the liquid crystal molecules in a φ cell 64 viewed from the top. The two layers 70 and 72 comprise the LC molecules. The liquid crystals are denoted by reference numeral 74. The twist angles are always smaller than ±φ and minimize the elastic twist energy. The orientation of the LC molecules in the φ cell viewed from the top is illustrated in FIG. 5c.

There are two radially defective lines, which separate areas of opposite twists as indicated by reference numerals 76 and 78. The defective lines are parallel to the cell axis; they originate close to the center of symmetry and jointly form a straight line. A typical diameter of the center area with an undefined LC orientation is 20 μm. As can be seen from FIG. 5a, the incident polarized radiation 66 can first see the straight aligned layer 70 and secondly the radially oriented layer 72.

It should be noted that the device 14 for generating radially polarized radiation also includes other embodiments (not shown).

FIG. 6 shows a laser 80 which emits radially polarized radiation. In this embodiment, the radiation source 12 and the device 14 for generating radially polarized radiation consist of one device. More details of a laser-emitting radially polarized radiation beam are described in the publication by R. Oron et al.: “The formation of laser beams with pure azimuthal or radial polarization”, Appl. Phys. Lett 77 (21) 3322 (2000). A detailed description of the laser will therefore not be given here. The laser comprises a gain medium 82, and a window 84 for coupling out the radially polarized beam 16. Note that the gain medium must be relatively isotropic.

FIG. 7 is a cross-sectional view of a read/write head 100 for an optical storage medium, a record carrier based on a tapered optical fiber with a bull's eye structure at its end. The read/write head comprises a waveguide 102 having an end face 104 positioned opposite a record carrier 106. In general, the end face 104 comprises a surface feature 26 with regular valleys 34 and hills 36. The means for generating radially polarized light generally comprises a radiation source 12 and a device 14 for converting the radiation emitted from the radiation source 12 into radially polarized radiation 16.

Radially polarized radiation 16 is incident on the metal plate 18 comprising the surface features and excites surface plasmons therein. The radially polarized radiation enhances the optical transmission through the aperture 24.

FIG. 8 is a schematic diagram of an example of an optical path in an optical pick-up unit with a read/write head 100. The Figure shows the device 14, particularly an LC-cell as in FIG. 6, for generating the radially polarized radiation. The metal plate 18 having the aperture is also shown.

The radiation source 12 emits a linearly polarized radiation beam, which passes through an optical lens 108. The device 14 for generating radially polarized radiation is arranged behind the optical lens, generating a radially polarized radiation beam 16. The radiation beam 16 passes through a beam-splitting element 110, is focused by a lens 112 and enters the read/write head 100 comprising the metal plate 18 with surface features. The record carrier 106 is positioned opposite the read/write head 100. The reflected radiation beam passes through the beam splitter 110 and a lens 114, and is detected by a detection element 116.

The radially polarized radiation beam 16 used as the radiation beam which scans (reads/writes) the record carrier 106 has an enhanced intensity as compared to conventional optical pick-up units.

The basic idea of the invention is the combination of radially polarized radiation with a metal plate having a surface feature 26 and an aperture 24, through which radially polarized radiation passes. The object of the invention is to enhance the optical transmission of radiation through this aperture of the metal plate 18 by using radially polarized radiation 16. The optical transmission is enhanced by exciting surface plasmons using the proper polarization. In this context, proper polarization is understood to mean that the polarization vector of the radiation is always perpendicular to the grooves of the surface feature 26 of metal plate 18. The invention includes several embodiments for generating radially polarized radiation as well as different embodiments of the metal plate 18 with different surface features 26.

1. An apparatus for enhanced transmission of radiation, comprising at least one radiation source (12), a metal plate (18) with a first (20) and a second (22) surface and at least one aperture (24) provided in the metal plate (18) and extending from the first (20) to the second (22) surface, the metal plate (18) having a periodic surface topography (26) provided on at least one of the first (20) and the second (22) surfaces, and radiation (13) coming from the radiation source (12) and being incident on one of the surfaces of the metal plate (18) interacts with a surface plasmon mode on at least one of the surfaces (20,22) of the metal plate (18), thereby enhancing transmission of radiation through the at least one aperture (24) of the metal plate (18), characterized in that the apparatus for enhanced optical transmission comprises means (15) for generating radially polarized radiation (16), which is incident on one of the surfaces (20,22) of the metal plate (18) with a surface topography (26), resulting in a more efficient coupling of the radiation to the plasmons and thereby in a further enhancement of the optical transmission.

2. An apparatus according to claim 1, characterized in that the means (15) for generating radially polarized radiation (16) comprises a radiation source (12) for emitting linearly polarized radiation (13) and a device (14) for changing the linearly polarized radiation (13) into radially polarized radiation (16).

3. An apparatus according to claim 1, characterized in that the device (14) comprises a Lee-type primary grating to form radially polarized radiation (16).

4. An apparatus according to claim 1, characterized in that the device (14) comprises a quarter-wave plate (42).

5. An apparatus according to claim 1, characterized in that the device (14) comprises a quarter-wave plate (42) and a phase plate (56).

6. An apparatus according to claim 1, characterized in that the device (14) comprises a liquid crystal cell (LC) (64).

7. An apparatus according to claim 1, characterized in that the means (15) comprises a laser radiation source emitting radially polarized radiation (16).

8. An apparatus according to claim 1, characterized in that the metal plate (18) comprises a film made of a metal and/or a semiconductor material.

9. An apparatus according to claim 1, characterized in that the metal plate (18) comprises surface features (27) on one and/or two of the surfaces (20,22).

10. An apparatus according to claim 1, characterized in that the surface feature (27) comprises at least two protruding and/or recessed structural surface features (27).

11. An apparatus according to claim 1, characterized in that the surface topography (26) comprises a plurality of surface features (27) formed as dimples and/or holes arranged in a periodic or quasi-periodic manner in at least one direction originating from the aperture (24).

12. An apparatus according to claim 1, characterized in that the surface features (27) are made of, defined by or filled with a material having a refractive index which is different from the refractive index of the material of the surface features (27).

13. An apparatus according to claim 1, characterized in that the surface features (27) forming the surface topography (26) are arranged symmetrically around the aperture (24).

14. An apparatus according to claim 1, characterized in that the surface features (27) forming the surface topography (26) are arranged asymmetrically around the aperture (24).

15. An apparatus according to claim 1, characterized in that the surface topography (26) of the first surface (20) and the surface topography (26) of the second surface (22) are identical.

16. An apparatus according to claim 1, characterized in that the at least one dimensional parameter and/or shape characteristic of the surface topography of the first surface (20) is different from at least one corresponding dimensional parameter and/or shaped characteristic of the surface topography of the second surface (22).

17. An apparatus according to claim 1, characterized in that the period or quasi-period of a surface topography (26) of the first surface (20) is different from the period or quasi-period of the surface topography (26) of the second surface (22).

18. An apparatus according to claim 1, characterized in that the metal plate (18) is mounted on or in front of the exit surface of a radiation-emitting or transmitting device or part.

19. A read/write head for an optical data storage media comprising an apparatus as claimed in claim 1.

20. A near field optical scanning microscope comprising an apparatus as claimed in claim 1.

21. A bright radiation source, characterized in that it comprises an apparatus as claimed in claim 1.

22. A method of enhancing, in particular doubling, the optical transmission of a radiation beam in a device (14) using radiation in the nanometer range and a sub-wavelength aperture (24) using radially polarized radiation (16) incident on a metal plate (18) with surface features (27) to achieve the excitation of plasmons by every photon from the radiation beam (16) incident on the metal plate (18).

23. Use of an apparatus for doubling the optical transmission, the apparatus comprising:
a radiation source (12);
a means (15) for generating a radially polarized radiation beam (16) and;
a metal plate (18) with a first surface (20) and a second surface (22) and at least one aperture (24) provided in the metal plate (18) and extending from the first (20) to the second surface (22);
a periodic surface topography (26) provided on at least one of the first (20) and the second (22) surfaces of the metal plate (18), wherein radiation coming from the radiation source (12) and being incident on one of the surfaces (20,22) of the metal plate (18) interacts with the surface plasmon mode on at least one of the surfaces (20,22) of the metal plate (18), thereby enhancing transmission of radiation through the at least one aperture (24) of the metal plate (18), the radiation incident on the surface feature (27) of the metal plate (18) being radially polarized radiation (16) with an electric field vector perpendicular to the surface features (27).
